(19) United States
(12) Patent Application Publication
(10) Pub. No.: US 2025/0094799 A1
(43) Pub. Date: Mar. 20, 2025

(54) COMPUTER-READABLE RECORDING MEDIUM STORING MACHINE LEARNING PROGRAM, MACHINE LEARNING METHOD, AND INFORMATION PROCESSING APPARATUS

(71) Applicant: Fujitsu Limited, Kawasaki-shi (JP)

(72) Inventors: Sou HASEGAWA, Mountain View, CA (US); Akira NAKAGAWA, Sagamihara (JP)

(73) Assignee: Fujitsu Limited, Kawasaki-shi (JP)

(21) Appl. No.: 18/828,051

(22) Filed: Sep. 9, 2024

(30) Foreign Application Priority Data
Sep. 15, 2023 (JP) 2023-150449

(51) Int. Cl. G06N 3/08; G06N 3/0455

(52) U.S. Cl. CPC G06N 3/08; G06N 3/0455

(57) ABSTRACT

A non-transitory computer-readable recording medium stores a machine learning program for causing a computer to execute a process including: inputting first data to an encoder, and acquiring third data obtained by adding noise to second data output by the encoder; inputting the third data to a decoder that corresponds to inverse computation of the encoder, and acquiring fourth data output by the decoder; and training the encoder and the decoder based on a loss function that includes the third data and an error between the first data and the fourth data.

### CROSS-REFERENCE TO RELATED APPLICATION

This application is based upon and claims the benefit of priority of the prior Japanese Patent Application No. 2023-150449, filed on Sep. 15, 2023, the entire contents of which are incorporated herein by reference.

### FIELD

The embodiments discussed herein are related to a computer-readable recording medium storing a machine learning program, a machine learning method, and an information processing apparatus.

### BACKGROUND

In related art, in fields such as image or natural language processing, a latent representation (also referred to as a latent variable or a latent space) that captures features of data is generated by using a generative deep learning model (hereafter, referred to as a generative model or a model). This generative model is trained by machine learning based on a large amount of unlabeled data. The generative model is also referred to as an autoencoder.

Japanese Laid-open Patent Publication Nos. 2022-20138 and 2022-15573, Japanese National Publication of International Patent Application No. 2022-533264, and U.S. Patent Application Publication No. 2019/0327501 are disclosed as related art.

### SUMMARY

According to an aspect of the embodiments, a non-transitory computer-readable recording medium stores a machine learning program for causing a computer to execute a process including: inputting first data to an encoder, and acquiring third data obtained by adding noise to second data output by the encoder; inputting the third data to a decoder that corresponds to inverse computation of the encoder, and acquiring fourth data output by the decoder; and training the encoder and the decoder based on a loss function that includes the third data and an error between the first data and the fourth data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for describing a model of the related art;

FIG. 2 is an explanatory diagram for describing a model of the related art;

FIG. 3 is an explanatory diagram for describing a model of the related art;

FIG. 4 is an explanatory diagram for describing an overview of a model according to an embodiment;

FIG. 5 is a block diagram illustrating a functional configuration example of an information processing apparatus according to the embodiment;

FIG. 6 is a flowchart illustrating an operation example of the information processing apparatus according to the embodiment;

FIG. 7 is an explanatory diagram for describing an overview of a model according to a modification example;

FIG. 8 is a flowchart illustrating an operation example of an information processing apparatus according to the modification example; and

FIG. 9 is an explanatory diagram for describing a configuration example of a computer.

### DESCRIPTION OF EMBODIMENTS

The generative model includes an encoder and a decoder. Input data is input to the encoder, and thus, a latent representation having a lower dimension and a smaller amount of data than the input data are generated. The latent representation is input to the decoder, and thus, output data that is restored data of the input data is generated.

The encoder and the decoder are trained by performing machine learning to reduce a restoration error between the input data and the output data. The input data is input to the encoder of the trained generative model, and thus, a latent representation in which features of the input data are captured is obtained. For example, the trained generative model has a role of quantitatively obtaining features of input data, such as sampling related to the input data, feature amount generation, explanatory variable generation, and data distribution acquisition. Accordingly, the generative model may be used for prediction, identification, and the like based on the input data.

However, in the above-described related arts, there is a problem that convergence of parameters of the encoder and the decoder deteriorates due to variation of a restoration error at the time of machine learning and the machine learning is likely to become unstable. For example, in a case where the number of parameters of the encoder and the decoder increases and a model size is large, it is difficult to converge the parameters.

In one aspect, an object is to provide a machine learning program, a machine learning method, and an information processing apparatus capable of improving stability at the time of machine learning of a generative model.

Hereinafter, a machine learning program, a machine learning method, and an information processing apparatus according to embodiments will be described with reference to the drawings. In the embodiments, elements having the same functions are denoted by the same reference numerals, and thus, redundant description thereof will be omitted. The machine learning program, the machine learning method, and the information processing apparatus to be described below in the embodiments are merely illustrative and are not intended to limit the embodiments. The individual embodiments below may be appropriately combined within a scope free from contradiction.

### (Overview of Embodiment)

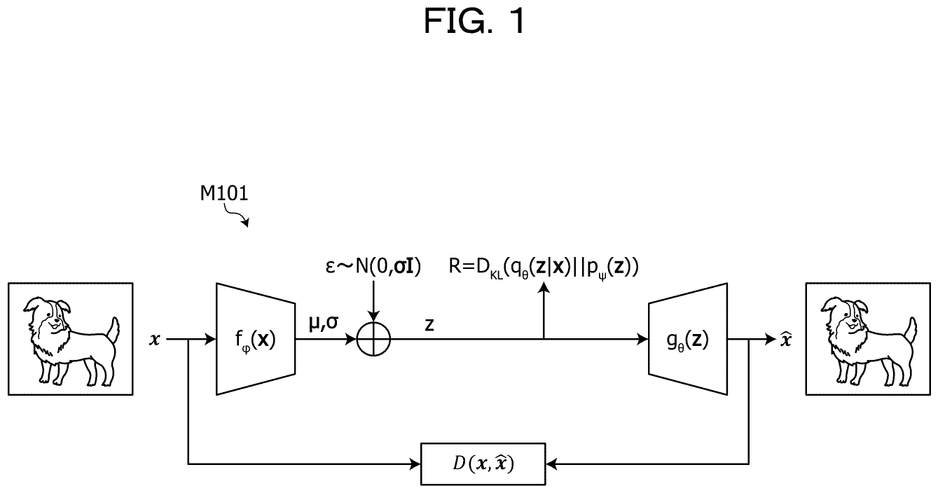

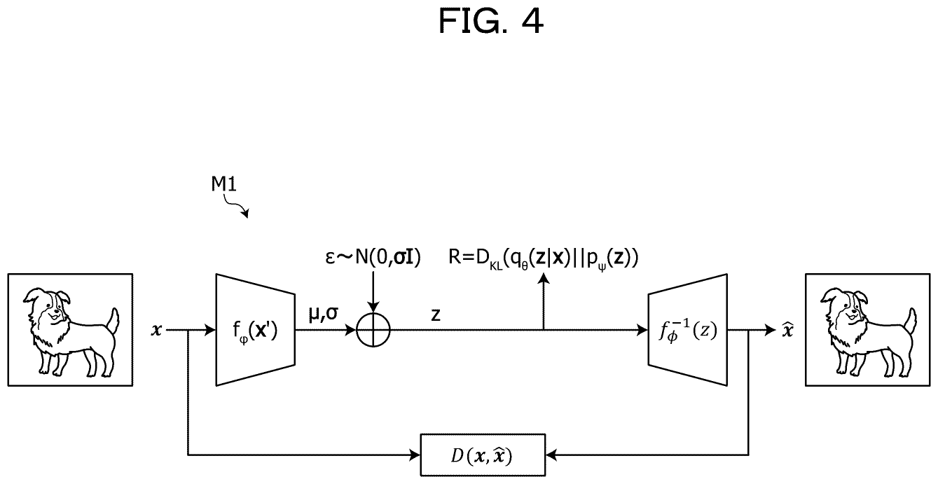

First, an overview of a model according to an embodiment will be described while being compared with models of related art with reference to FIGS. 1 to 4. FIGS. 1 to 3 are explanatory diagrams for describing models of the related art. FIG. 4 is an explanatory diagram for describing the overview of the model according to the embodiment.

As illustrated in FIG. 1, as a model M101 of the related art, there is a variational autoencoder (VAE). The model M101 includes an encoder (f_{φ}(x)) and a decoder (g_{θ}(z)).

In the model M101, when input data (x) is input, the encoder (f_{φ}(x)) calculates f (x) based on a parameter (φ). For example, the encoder (f_{φ}(x)) outputs μ and σ based on a calculation result of f_{φ}(x). μ is an average of the calculation result. σ is a standard deviation of the calculation result.

In the model M101, ε (noise ε) according to a normal distribution of N(0, σI) is added to μ (I is a unit matrix), and thus, a latent variable z is acquired. In the model M101, when the latent variable z is input, the decoder (g_{θ}(z)) calculates g_{θ}(z) based on a parameter θ. The decoder (g_{θ}(z)) outputs output data (x(hat)) that is a calculation result of g_{θ}(z).

The model M101 calculates a restoration error (D(x, x(hat))) between the input data (x) and the output data (x(hat)) and an encoded information amount (R) at the time of machine learning using the input data (x).

The restoration error D is a distance between the input data (x) and the output data (x(hat)), and is calculated based on, for example, cross-entropy, a difference square sum, or the like.

The encoded information amount R is, for example, a Kullback-Leibler divergence (D_{KL}), and is obtained by quantifying a difference between a probability distribution (p_{φ}(z)) of the latent variable z and a prior distribution (q_{θ}(z|x)) of the latent variable z.

At the time of machine learning, an information processing apparatus of the related art computes a value of a loss function L of E including the restoration error D and the encoded information amount R, and updates the parameters (θ, φ) of the encoder and the decoder such that the value of the loss function L decreases as represented in Equation (1) below. β is a correction coefficient of the encoded information amount R, and is a value set in advance.

$$θ , ϕ = {arg min}_{θ , ϕ} ( {E}_{x ∼ p ( x ) , ε ∼ N ( 0 , σ I )} [ D + β \cdot R ] ) \qquad ( 1 )$$

As described above, since the model M101 is optimized by adding noise to the latent variable and using the restoration error D and the encoded information amount R, a cluster of information is formed over a latent space, and a latent space having high interpretability may be formed.

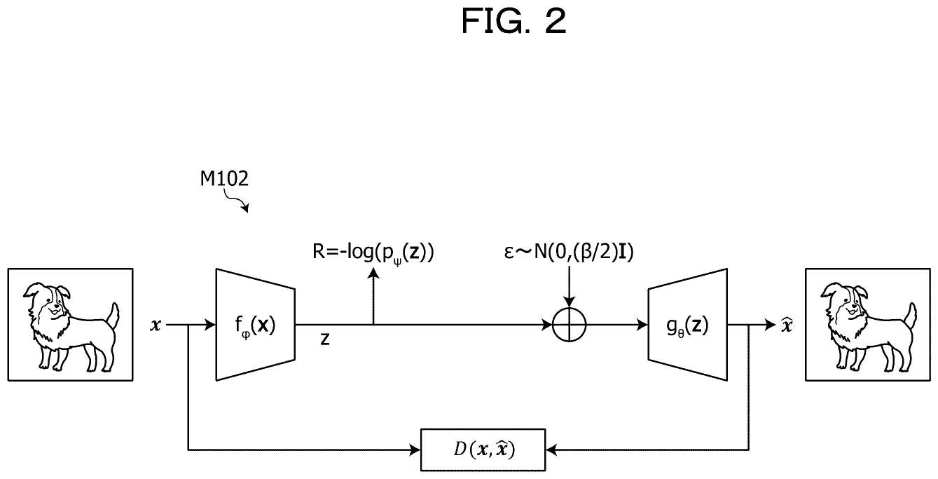

As illustrated in FIG. 2, as in the model M101, a model M102 of the related art may include an encoder (f_{φ}(x)) and a decoder (g_{θ}(z)), and an output of the encoder (f_{φ}(x)) may be used as a latent variable z as it is. In the model M102, an encoded information amount R is calculated as R=−log(p_{φ}(z)) based on a probability distribution (p_{φ}(z)) of the latent variable z. In the model M102, data obtained by adding noise E of N(0, (β/2)I) to the latent variable z is input to the decoder (g_{θ}(z)).

At the time of machine learning of the model M102, the information processing apparatus of the related art computes a value of a loss function L of E including the restoration error D and the encoded information amount R, and updates the parameters of the encoder and the decoder and the probability distribution of the latent variable (θ, φ, p_{φ}) such that the value of the loss function L decreases as represented in Equation (2) below.

$$θ , ϕ , ψ = {arg min}_{θ , ϕ , ψ} ( {E}_{x ∼ p ( x ) , ε ∼ N ( 0 , ( β / 2 ) I )} [ D + β \cdot R ] ) \qquad ( 2 )$$

As described above, in the model M102, “rate distortion optimization” that reduces the restoration error D and the encoded information amount R is simultaneously performed, and thus, it is possible to obtain a latent space (formation of a cluster of formation, acquisition of explanatory variables, and the like) having high interpretability. However, in the models M101 and M102 of the related art described above, convergence of the parameters (θ, φ) of the encoder and the decoder deteriorates due to variation of the restoration error D, and thus, machine learning is likely to become unstable.

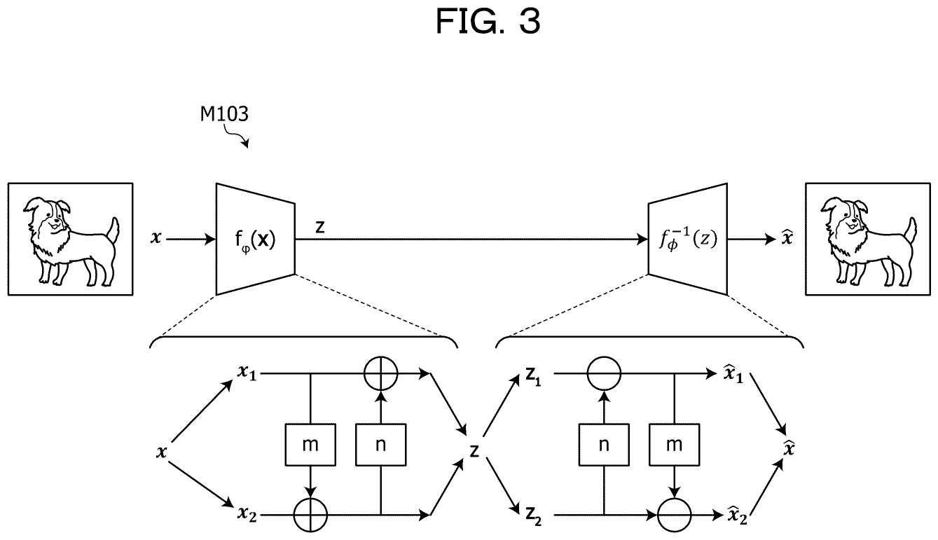

As illustrated in FIG. 3, as a model M103 of the related art, there is a flow-based model. For example, in the model M103, a decoder is an inverse function (f_{φ}⁻¹(z)) of an encoder (f_{φ}(x)), and parameters φ(m, n) of the encoder and the decoder are shared.

At the time of machine learning of the model M103, the information processing apparatus of the related art performs optimization such that a value of a loss function L decreases and trains the encoder (f_{φ}(x)) as represented in Equation (3) below. In such a flow-based model (model M103), a likelihood of an input distribution is directly maximized by a reversible encoder.

$$ϕ = {arg min}_{ϕ} ( {E}_{x ∼ p ( x )} [ log p ( z ) + log \vert det ( \frac{\partial z}{\partial x} ) \vert ] ) \qquad ( 3 )$$

Accordingly, a data distribution may be obtained with high accuracy in the flow-based model, and highly accurate sampling may be performed. However, in the flow-based model, since noise is not added to the latent variable z, it is difficult to form a cluster of information over a latent space, and the latent space has low interpretability.

For the optimization of the models M101 and M102 of the related art, the parameters (θ, φ) of the encoder and the decoder are to be updated to reduce both the restoration error D and the encoded information amount R in a balanced manner, and machine learning is likely to become unstable (the convergence of the parameters is poor).

The restoration error D related to the models M101 and M102 of the related art may be approximately expanded to a form including a term (D(x, x(breve))) of A and a term (D(x(breve), x(hat))) of B as in Equation (4) below. Here, x (breve) in Equation (4) refers to a case where noise is not added to the latent variable z.

$$D ( x , \hat{x} ) ≅ {\underbrace{D ( x , {x}^{⌣} )}}_{A} + {\underbrace{D ( {x}^{⌣} , \hat{x} )}}_{B} \qquad ( 4 )$$

In the expansion of Equation (4) above, the term of A is a term that promotes g_{θ}(x)=f_{φ}⁻¹(x), and convergence becomes difficult as a model size increases. The term of B is a term that maintains a feature of the input data (x), and converges at an initial stage of training. For example, it has been found that whether or not the convergence of the term of A is good greatly affects whether or not performance (convergence) of the models M101 and M102 of the related art is good.

The term of A is consistently 0 in the case of the encoder of the flow-based model (model M103). For example, the flow-based model may be adopted for stabilization of machine learning. However, since the latent space has low interpretability, there is no positive reason to divert the flow-based model to an autoencoder of a generative model.

As illustrated in FIG. 4, in a model M1 according to the embodiment, an autoencoder capable of reversible computation is used as in a flow-based model. The model M1 acquires a latent variable z by adding noise to an output of an encoder (f_{φ}(x)), and updates a parameter (φ) of the encoder (decoder) based on an encoded information amount based on the latent variable z and a restoration error D.

For example, in the model M1, when input data (x) is input, the encoder (f_{φ}(x)) calculates f_{φ}(x) based on the parameter (φ). For example, the encoder (f_{φ}(x)) outputs μ and σ based on a calculation result of f_{φ}(x). μ is an average of the calculation result. σ is a standard deviation of the calculation result.

Thereafter, in the model M1, ε (noise ε) according to a normal distribution of N(0, σI) is added to μ, and thus, the latent variable z is acquired. In the model M1, the decoder is f_{φ}⁻¹(z), and corresponds to an inverse computation (inverse function) of the encoder (f_{φ}(x)). When the latent variable z is input, this decoder calculates f_{φ}⁻¹(z) based on the parameter q. The decoder outputs output data (x(hat)) that is a calculation result of f_{φ}⁻¹(z).

An information processing apparatus of the embodiment calculates a restoration error (D(x, x(hat))) between the input data (x) and the output data (x(hat)) and an encoded information amount (R) at the time of machine learning of the model M1 using the input data (x).

As in the models M101 and M102, the restoration error D related to the model M1 is a distance between the input data (x) and the output data (x(hat)), and is calculated based on, for example, cross-entropy, a difference square sum, or the like.

As in the models M101 and M102, the encoded information amount R related to the model M1 is, for example, a Kullback-Leibler divergence (D_{KL}). For example, the encoded information amount R related to the model M1 is obtained by quantifying a difference between a probability distribution (p_{φ}(z)) of the latent variable z and a prior distribution (q_{θ}(z|x)) of the latent variable z.

The information processing apparatus of the embodiment computes a value of a loss function L of E including the restoration error D and the encoded information amount R, and updates the parameter (φ) of the encoder (decoder) such that the value of the loss function L decreases as represented in Equation (5) below.

$$ϕ = arg min ( {E}_{x \sim p ( x ) , ε \sim N ( 0 , ( \frac{β}{2} ) l )} [ - β {D}_{KL} ( {q}_{ϕ} ( z \vert x ) ‖ {p}_{ψ} ( z ) ) + D ( x , \hat{x} ) ] ) \qquad ( 5 )$$

Thus, in the information processing apparatus of the embodiment, highly accurate sampling may be implemented in the machine learning of the model M1, and the convergence may be improved (machine learning may be performed stably) since the term of A in the restoration error D is consistently 0. In the model M1, since the latent variable z is obtained by adding noise to the output of the encoder (f_{φ}(x)), a cluster of information is formed over a latent space, and a latent space having high interpretability may be formed.

### Embodiment

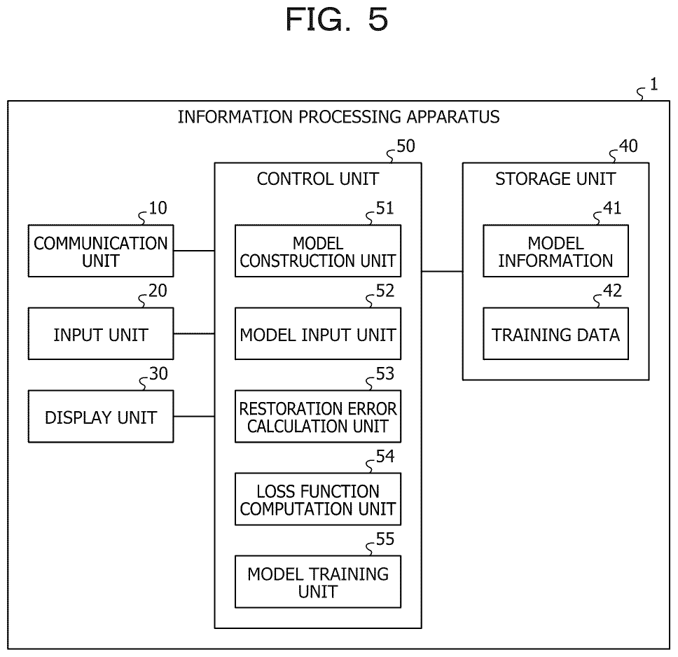

FIG. 5 is a block diagram illustrating a functional configuration example of the information processing apparatus according to the embodiment. As illustrated in FIG. 5, an information processing apparatus 1 includes a communication unit 10, an input unit 20, a display unit 30, a storage unit 40, and a control unit 50.

The communication unit 10 receives various types of data from an external device via a network. The communication unit 10 is an example of a communication device. For example, the communication unit 10 may receive model information 41, training data 42, and the like from an external device.

The input unit 20 is an input device that inputs various types of information to the control unit 50 of the information processing apparatus 1. The input unit 20 corresponds to a keyboard, a mouse, a touch panel, or the like. The display unit 30 is a display device that displays information output from the control unit 50.

The storage unit 40 stores data such as the model information 41 and the training data 42. The storage unit 40 corresponds to a semiconductor memory element such as a random-access memory (RAM) or a flash memory, or a storage device such as a hard disk drive (HDD).

The model information 41 includes the parameter φ and the like related to the model M1 described above. The training data 42 is data used in the machine learning of the model M1, and is, for example, image data, text data, or the like used in image or natural language processing, and the like.

The control unit 50 includes a model construction unit 51, a model input unit 52, a restoration error calculation unit 53, a loss function computation unit 54, and a model training unit 55. For example, the control unit 50 is implemented by a central processing unit (CPU), a graphics processing unit (GPU), a hard wired logic such as an application-specific integrated circuit (ASIC) or a field-programmable gate array (FPGA), or the like.

The model construction unit 51 is a processing unit that constructs the model M1 according to the embodiment. For example, the model construction unit 51 constructs the encoder (f_{φ}(x)) and the decoder (f_{φ}⁻¹(z)) of the model M1 based on the parameter φ included in the model information 41 stored in the storage unit 40.

The model input unit 52 is a processing unit that inputs data to the model M1 constructed by the model construction unit 51. For example, the model input unit 52 reads the training data 42 from the storage unit 40 at the time of machine learning, and inputs the training data 42 as the input data (x) to the encoder (f_{φ}(x)) of the model M1. Thereafter, the model input unit 52 adds noise to (x′) output by the encoder (f_{φ}(x)) with respect to the input data (x), and acquires the latent variable z. Thereafter, the model input unit 52 inputs the latent variable z to the decoder (f_{φ}⁻¹(z)) and acquires the output data (x(hat)) output by the decoder.

The restoration error calculation unit 53 is a processing unit that calculates the restoration error D(x, x(hat)) between the input data (x) and the output data (x(hat)). For example, the restoration error calculation unit 53 calculates the distance between the input data (x) and the output data (x(hat)) based on the cross-entropy, the difference square sum, or the like.

The loss function computation unit 54 is a processing unit that computes the loss function L of E including the latent variable z and the restoration error D. For example, the loss function computation unit 54 calculates the Kullback-Leibler divergence (D_{KL}) based on the probability distribution (p_{φ}(z)) of the latent variable z and the prior distribution (q_{θ}(z|x)) of the latent variable z, and sets the Kullback-Leibler divergence as the encoded information amount R. Thereafter, the loss function computation unit 54 computes the loss function L as in Equation (5) based on the restoration error D and the Kullback-Leibler divergence (D_{KL}).

The model training unit 55 is a processing unit that executes training (machine learning) of the encoder and the decoder in the model M1 based on the computation result of the loss function L. For example, as represented in Equation (5), the model training unit 55 updates the parameter (φ) of the encoder (decoder) such that the value of the loss function L decreases. Thereafter, the model training unit 55 stores the updated parameter value in the model information 41.

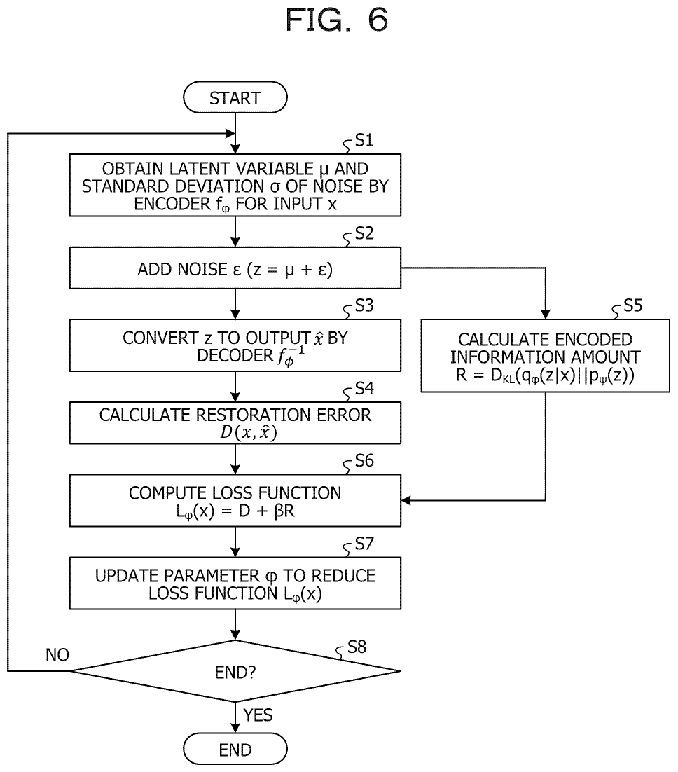

FIG. 6 is a flowchart illustrating an operation example of the information processing apparatus 1 according to the embodiment. Before the start of the processing illustrated in FIG. 6, it is assumed that the model M1 has been constructed by the model construction unit 51.

As illustrated in FIG. 6, when the processing is started, the model input unit 52 reads the training data 42 and inputs the training data 42 as the input data (x) to the encoder (f_{φ}(x)) of the model M1. Accordingly, the information processing apparatus 1 obtains a latent variable (μ) and a standard deviation σ of noise for the input (x) by the encoder f_{φ}(S1). Thereafter, the model input unit 52 adds the noise ε to the latent variable μ to obtain the latent variable z (S2).

Thereafter, the model input unit 52 inputs the latent variable z to the decoder (f_{φ}⁻¹(z)), and the decoder converts z into the output (x(hat)) (S3).

Thereafter, the restoration error calculation unit 53 calculates the restoration error D(x, x(hat)) between the input (x) and the output (x(hat)) (S4).

After S2, the loss function computation unit 54 calculates the encoded information amount R (S5). After S4, the loss function computation unit 54 computes the loss function L_{φ}(x)=D+βR based on the restoration error D and the encoded information amount R (S6).

Thereafter, based on the computation result of the loss function L_{φ}(x), the model training unit 55 updates the parameter (φ) of the encoder (decoder) such that the value of the loss function L_{φ}(x) decreases (S7).

Thereafter, the model training unit 55 determines whether or not to end processing based on whether or not an end condition is satisfied (S8). The end condition indicates a condition for ending the machine learning related to the model M1. For example, the end condition includes a case where the value of the loss function L_{φ}(x) is less than a predetermined threshold value, a case where the processing of S1 to S7 is repeated a predetermined number of times, and the like.

In a case where the processing is ended (S8: Yes), the model training unit 55 stores the updated parameter value in the model information 41 and ends the processing. In a case where the processing is not ended (S8: No), the model training unit 55 returns the processing to the S1.

### Modification Example

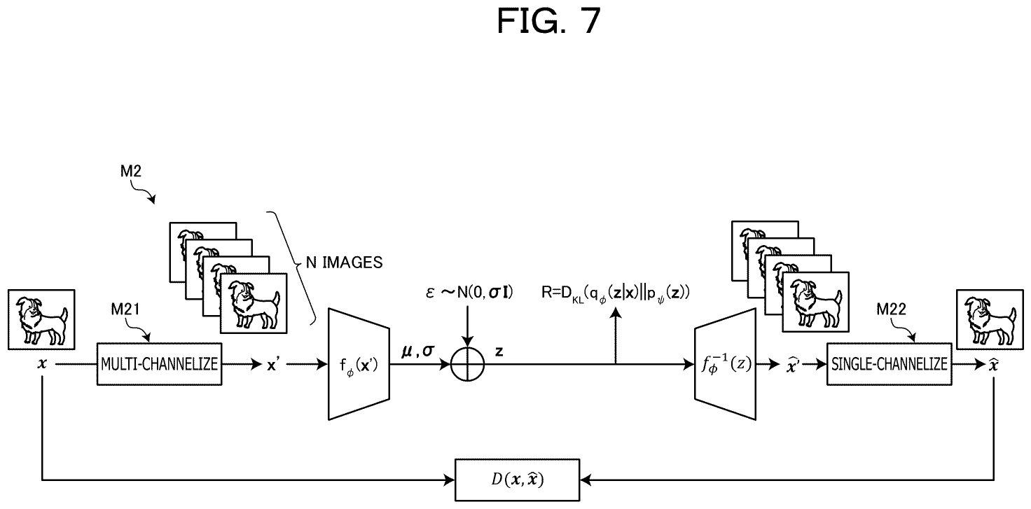

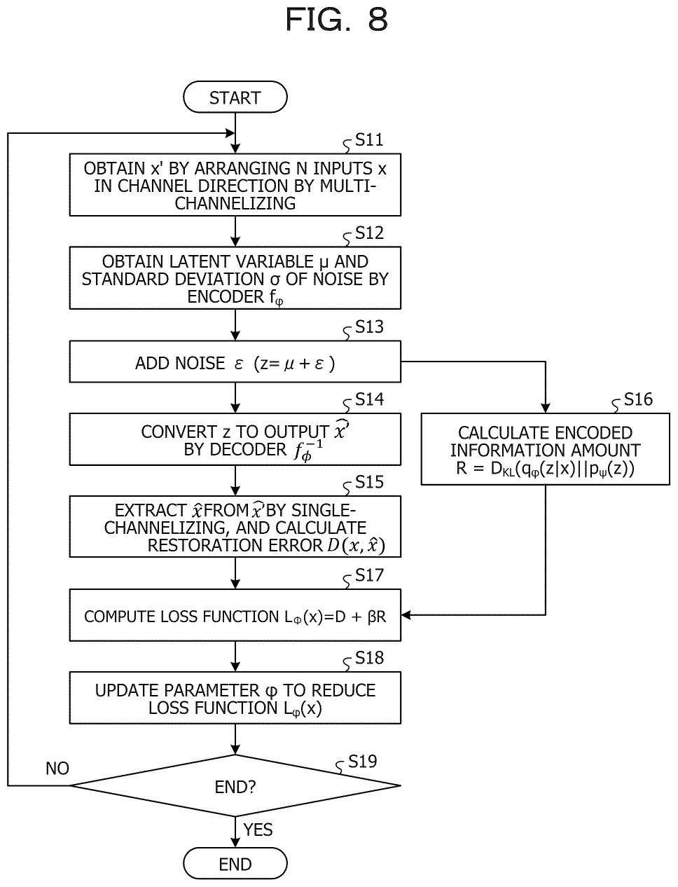

Next, a modification example of the above-described embodiment will be described with reference to FIGS. 7 and 8. FIG. 7 is an explanatory diagram for describing an overview of a model according to the modification example. FIG. 8 is a flowchart illustrating an operation example of the information processing apparatus 1 according to the modification example.

As illustrated in FIG. 7, in a model M2 according to the modification example, an input x is a multi-channelized input (x′) (M21), and is input to an encoder (f_{φ}(x′)). For example, the model input unit 52 multi-channelizes the input x by copying the input x for the number of channels, and inputs the multi-channelized input to the encoder. For example, in a case where the input x is an image and the number of channels is N, an input (x′) in which N images are arranged in a channel direction is input to the encoder. Accordingly, a multi-channelized latent variable z is obtained.

Thereafter, the model input unit 52 inputs the multi-channelized latent variable z to a decoder (f_{φ}⁻¹(z)) to obtain a multi-channelized output (x′(hat)). The model input unit 52 single-channelizes this output (x′(hat)) (M22) to obtain an output (x(hat)). In the single-channelizing, one channel may be arbitrarily selected from the multi-channelized output (x′(hat)), or an average value of all channels may be obtained for integration into one channel.

As in FIG. 6, it is assumed that the model M1 has been constructed by the model construction unit 51 before the start of the processing illustrated in FIG. 8.

As illustrated in FIG. 8, when processing is started, the model input unit 52 reads the training data 42 and sets the training data 42 as the input data (x). Thereafter, the model input unit 52 obtains input data (x′) by arranging N inputs (x) in the channel direction by multi-channelizing (S11).

Thereafter, the model input unit 52 inputs the input data (x′) to the encoder (f_{φ}(x)) of the model M2. Accordingly, the information processing apparatus 1 obtains the latent variable (μ) and the standard deviation σ of noise for the input (x′) by the encoder f_{φ}(S12). Thereafter, the model input unit 52 adds the noise ε to the latent variable μ to obtain the latent variable z (S13).

Thereafter, the model input unit 52 inputs the latent variable z to the decoder (f_{φ}⁻¹(z)), and converts, by the decoder, z into the output (x′(hat)) (S14).

Thereafter, the model input unit 52 extracts a single-channel output (x(hat)) from the multi-channel outputs (x′(hat)) by single-channelizing. Thereafter, the restoration error calculation unit 53 calculates a restoration error D(x, x(hat)) between the input (x) and the output (x(hat)) (S15).

After S13, the loss function computation unit 54 calculates the encoded information amount R (S16). After S15, the loss function computation unit 54 calculates the loss function L_{φ}(x)=D+βR based on the restoration error D and the encoded information amount R (S17).

Thereafter, based on the computation result of the loss function L_{φ}(x), the model training unit 55 updates the parameter (φ) of the encoder (decoder) such that the value of the loss function L_{φ}(x) decreases (S18).

Thereafter, as in S8, the model training unit 55 determines whether or not to end the processing based on whether or not the end condition is satisfied (S19). In a case where the processing is ended (S19: Yes), the model training unit 55 stores the updated parameter value in the model information 41 and ends the processing. In a case where the processing is not ended (S19: No), the model training unit 55 returns the processing to the S11.

As described above, the information processing apparatus 1 inputs the input data (x) to the encoder of the model (M1), and acquires the data (z) obtained by adding noise to the data (x′) output by the encoder. The information processing apparatus 1 inputs the data (z) to the decoder that corresponds to inverse computation of the encoder, and acquires the output data (x(hat)) output by the decoder. The information processing apparatus 1 trains the encoder and the decoder in the model (M1) based on a loss function that includes the data (z) and an error between the input data (x) and the output data (x(hat)).

Thus, since the term of A in the restoration error D of Equation (4) is consistently 0 in the machine learning of the model (M1), the information processing apparatus 1 may improve the convergence (may perform machine learning stably). In the model (M1), since the data (latent variable z) is obtained by adding noise to the output of the encoder, a cluster of information is formed over a latent space, and a latent space having high interpretability may be formed.

The information processing apparatus 1 multi-channelizes the input data (x) and inputs the input data (x) to the encoder to acquire multi-channelized data (z). The information processing apparatus 1 inputs the multi-channelized data (z) to the decoder, single-channelizes the output of the decoder, and acquires the output data (x(hat)). As described above, since the information processing apparatus 1 performs machine learning by multi-channelizing the input data, it is possible to efficiently proceed with the machine learning.

Each constituent element of each apparatus illustrated in the drawings does not have to be physically configured as illustrated in the drawings. For example, the specific form of the distribution and integration of each apparatus is not limited to the illustrated form, and all or a part of the apparatus may be configured in arbitrary units in a functionally or physically distributed or integrated manner depending on various kinds of loads, usage statuses, and the like.

All or an arbitrary part of various processing functions to be performed in the control unit 50 of the information processing apparatus 1, such as the model construction unit 51, the model input unit 52, the restoration error calculation unit 53, the loss function computation unit 54, and the model training unit 55, may be executed over a CPU (or a microcomputer, such as a microprocessor unit (MPU) or a microcontroller unit (MCU)). It goes without saying that all or an arbitrary part of the various processing functions may be executed over a program analyzed and executed by a CPU (or a microcomputer, such as an MPU or MCU) or over hardware by wired logic. The various processing functions executed in the information processing apparatus 1 may be executed by cloud computing in which a plurality of computers collaborates with each other.

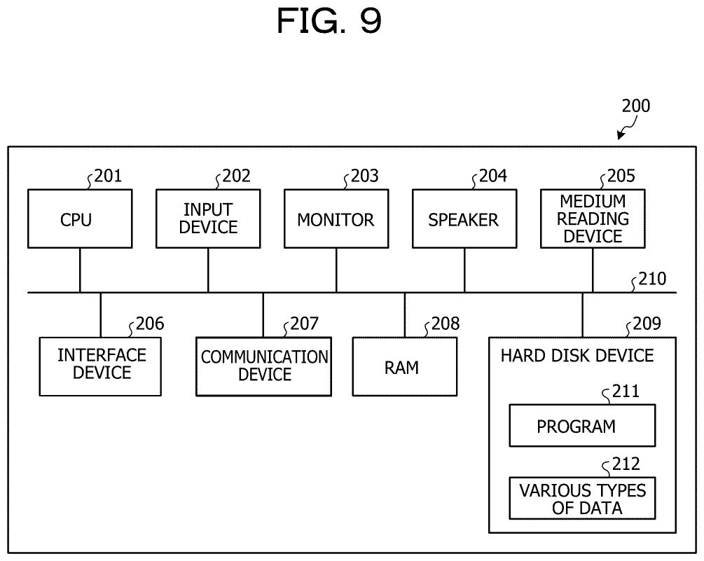

The various types of processing described in the above embodiment may be implemented by a computer executing a program prepared in advance. Hereinafter, an example of the (hardware) configuration of a computer that executes a program having the functions similar to those of the above embodiment will be described. FIG. 9 is an explanatory diagram for describing a configuration example of a computer.

As illustrated in FIG. 9, a computer 200 includes a CPU 201 that executes various types of arithmetic processing, an input device 202 that receives data input, a monitor 203, and a speaker 204. The computer 200 includes a medium reading device 205 that reads a program or the like from a storage medium, an interface device 206 for coupling to various devices, and a communication device 207 for communication with and coupling to an external device in a wired or wireless manner. The information processing apparatus 1 includes a RAM 208 that temporarily stores various types of information, and a hard disk device 209. The components (201 to 209) in the computer 200 are coupled to a bus 210.

The hard disk device 209 stores a program 211 for executing various types of processing in the functional configurations (for example, the model construction unit 51, the model input unit 52, the restoration error calculation unit 53, the loss function computation unit 54, and the model training unit 55) described in the above embodiment. The hard disk device 209 stores various types of data 212 to be referred to by the program 211. For example, the input device 202 receives input of operation information from an operator. For example, the monitor 203 displays various screens to be operated by an operator. For example, a printer or the like is coupled to the interface device 206. The communication device 207 is coupled to a communication network such as a local area network (LAN), and exchanges various types of information with an external device via the communication network.

The CPU 201 reads the program 211 stored in the hard disk device 209, loads the program in the RAM 208, and executes the program to perform various types of processing related to the above-described functional configurations (for example, the model construction unit 51, the model input unit 52, the restoration error calculation unit 53, the loss function computation unit 54, and the model training unit 55). The program 211 does not have to be stored in the hard disk device 209. For example, the program 211 stored in a storage medium readable by the computer 200 may be read and executed. For example, the storage medium readable by the computer 200 corresponds to a portable-type recording medium such as a compact disc read-only memory (CD-ROM), a Digital Versatile Disc (DVD), or a Universal Serial Bus (USB) memory, a semiconductor memory such as a flash memory, a hard disk drive, or the like. This program 211 may be stored in an apparatus coupled to a public network, the Internet, a LAN, or the like, and the computer 200 may read the program 211 from the apparatus and execute the program 211.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning program for causing a computer to execute a process comprising:
inputting first data to an encoder, and acquiring third data obtained by adding noise to second data output by the encoder;
inputting the third data to a decoder that corresponds to inverse computation of the encoder, and acquiring fourth data output by the decoder; and
training the encoder and the decoder based on a loss function that includes the third data and an error between the first data and the fourth data.

2. The non-transitory computer-readable recording medium according to claim 1, wherein
in the acquiring of the third data, multi-channelized third data is acquired by multi-channelizing the first data and inputting the multi-channelized first data to the encoder, and
in the acquiring of the fourth data, the fourth data is acquired by inputting the multi-channelized third data to the decoder and single-channelizing an output of the decoder.

3. The non-transitory computer-readable recording medium according to claim 1, wherein
the loss function adds, to the error, a value obtained by multiplying encoded information between a probability distribution and a prior distribution of the third data by a correction coefficient.

4. A machine learning method for causing a computer to execute a process comprising:
inputting first data to an encoder, and acquiring third data obtained by adding noise to second data output by the encoder;
inputting the third data to a decoder that corresponds to inverse computation of the encoder, and acquiring fourth data output by the decoder; and
training the encoder and the decoder based on a loss function that includes the third data and an error between the first data and the fourth data.

5. The machine learning method according to claim 4, wherein
in the acquiring of the third data, multi-channelized third data is acquired by multi-channelizing the first data and inputting the multi-channelized first data to the encoder, and
in the acquiring of the fourth data, the fourth data is acquired by inputting the multi-channelized third data to the decoder and single-channelizing an output of the decoder.

6. The machine learning method according to claim 4, wherein
the loss function adds, to the error, a value obtained by multiplying encoded information between a probability distribution and a prior distribution of the third data by a correction coefficient.

7. An information processing apparatus comprising:
a memory; and
a processor coupled to the memory and configured to:
input first data to an encoder;
acquire third data obtained by adding noise to second data output by the encoder;
input the third data to a decoder that corresponds to inverse computation of the encoder;
acquire fourth data output by the decoder; and
train the encoder and the decoder based on a loss function that includes the third data and an error between the first data and the fourth data.

8. The information processing apparatus according to claim 7, wherein
in a process to acquire the third data, multi-channelized third data is acquired by multi-channelizing the first data and inputting the multi-channelized first data to the encoder, and
in a process to acquire fourth data, the fourth data is acquired by inputting the multi-channelized third data to the decoder and single-channelizing an output of the decoder.

9. The information processing apparatus according to claim 7, wherein
the loss function adds, to the error, a value obtained by multiplying encoded information between a probability distribution and a prior distribution of the third data by a correction coefficient.
